(19) United States
(12) Patent Application Publication
(10) Pub. No.: US 2025/0117305 A1
(43) Pub. Date: Apr. 10, 2025

(54) SYSTEM AND METHOD FOR PREVENTATIVE MAINTENANCE OF PERSONAL COMPUTERS

(71) Applicants: Mark Gibbs, Hillsboro, OR (US); Etheric Mc Farlane, Portland, OR (US)

(72) Inventors: Mark Gibbs, Hillsboro, OR (US); Etheric Mc Farlane, Portland, OR (US)

(21) Appl. No.: 18/741,102

(22) Filed: Jun. 12, 2024

Related U.S. Application Data
(60) Provisional application No. 63/542,506, filed on Oct. 4, 2023.

(51) Int. Cl. G06F 11/30; G06F 11/07

(52) U.S. Cl. CPC G06F 11/3055; G06F 11/0751; G06F 11/3058

(57) ABSTRACT

The invention is a method to monitor the operational health of a PC to enable preventative maintenance. The monitoring is facilitated via a peripheral encoded with software containing information regarding PC components' proper functioning and the internal environment. The software monitors the PC and detects a fault when the components are malfunctioning. The software communicates the fault to an interested party that remedies the situation.

### PRIORITY CLAIM

This application claims priority to copending U.S. Application, Ser. No. 63/542,506 filed on Oct. 4, 2023, which is hereby incorporated by reference for all purposes

### BACKGROUND OF THE INVENTION

Personal computers (PC/PCs) are an integral part of personal and business life. Their use is equally ubiquitous as automobiles, household appliances, and mobile telephones. Like the former, the loss of PC use would cause just as much inconvenience and loss of work. Unlike the former, however, PCs lack essential features that ensure uninterrupted health and function of these crucial items. The goal of the invention is to improve the health of personal computers. In the current art, PCs are serviced only when they fail. Also, it's uncommon in the art to perform preventative maintenance checks on PCs. Additionally, unlike automobiles or household appliances, PCs do not have warning lights that indicate a pending problem. Thus, there is a need to monitor health and proper function to ensure continuous operation and communicate the issue to the user.

### SUMMARY OF THE INVENTION

The invention comprises installing hardware on the computer or motherboard that monitors the internal environment of the PC and the various components. When hardware detects non-favorable conditions or faults in components, the hardware wirelessly communicates the information to a wireless device or system. The device's owner could be the owner of the PC, the OEM, or a PC service provider.

### BRIEF DESCRIPTION OF THE DRAWINGS

FIG. 1 is a USB software storage device that will be used to store the software to monitor computer hardware. The USB is our choice for downloading or transferring the software into a computer.

FIG. 2 is a motherboard section where the USB port housing is plugged into the motherboard. For the purpose of the illustration is to show the USB location.

FIG. 3 three is a USB port adapter that shows the USB ports facing opposite directions.

FIG. 4 represents the software monitoring the hardware installed on the motherboard and sending information to the owner/customer and the manufacturer and/or the 3^{rd} party computer repair company.

FIG. 5 is an operational flow diagram of the invention.

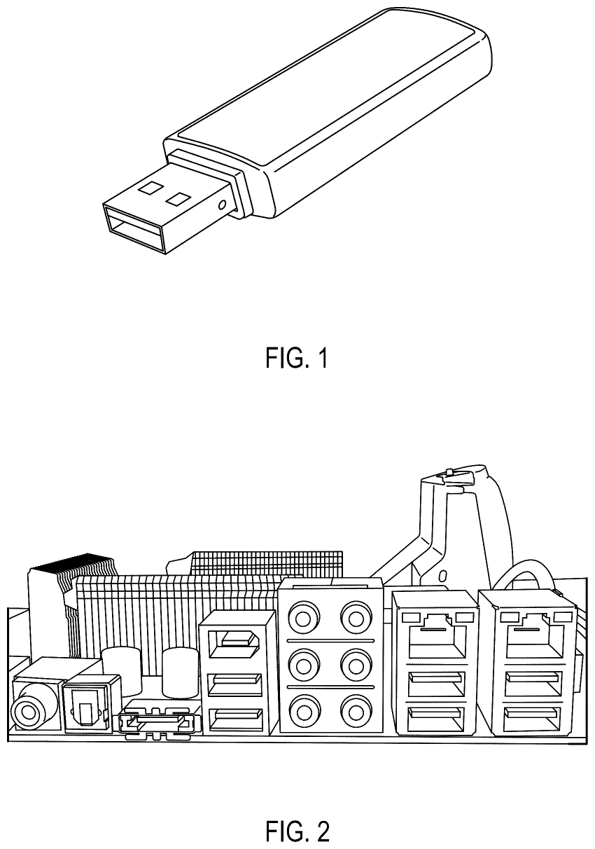

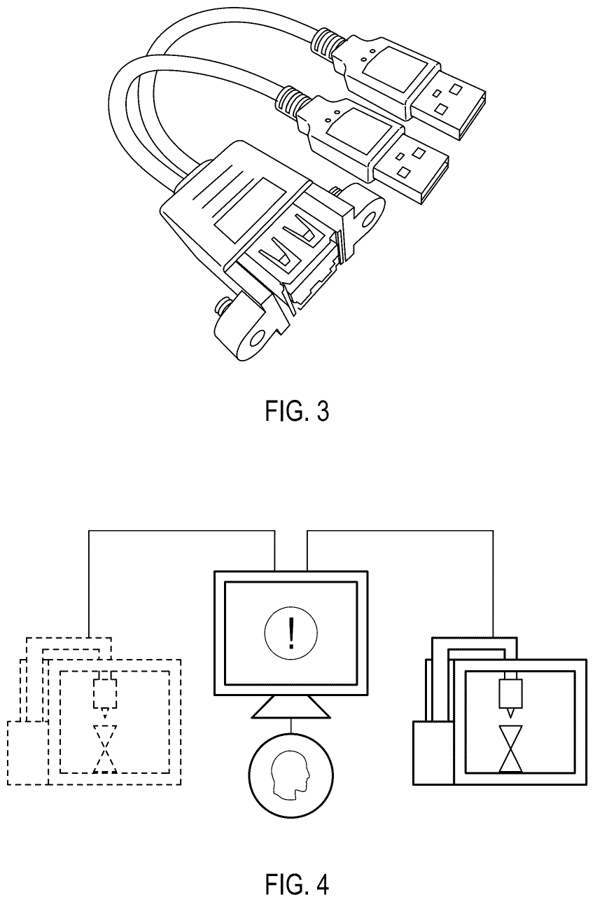

### DETAILED DESCRIPTION OF THE INVENTION

In one embodiment, a USB device is connected to the motherboard and contains the invention to track and monitor the life of hardware components and the motherboard's performance. The invention is programmed with performance data to compare to components in another PC, which acts as the standard or control. The invention monitors the performance of the components for fluctuation and changes that are early signs of failure or malfunction. Upon detecting a fluctuation or sign of malfunction, the invention sends an email to the interested party. The interested party could be the owner, the OEM, a designated repair service, or any combination of the latter. Such information will expedite the processing of warranty claims or the ordering the required parts. Another embodiment invention is located on a component that fits into a peripheral component interconnected express (PIC-E) slot. Similarly, the component will contain the invention of monitoring the PC's health.

Using either embodiment makes the computer a self-monitoring device to identify specific failing or malfunctioning components. The invention comprises a wireless card and a wireless receiver, such as the cell phone, Raspberry Pi, and the Cloud, which receives the information and sends it to the OEM, repair service, and owner.

Either embodiment, through its connection to the motherboard, periodically checks the performance of the hardware and devices. For example, the invention will monitor the RAM and the CPU and compare their performance to industry standards. It can also monitor the condition of the chipsets on the motherboard. Additionally, the invention will monitor the internal environment, and PC performance depends on internal temperature. For example, the invention can monitor the speed of the internal fans and the airflow throughout the case. The inside of the PC case should be maintained at 20 to 80° C. The invention can monitor the temperature and alert the appropriate parties of the deficiencies or adjust the airflow via the installed fans to bring the temperature back to the desired range.

### DETAILED DESCRIPTION OF THE INVENTION

With reference to FIG. 5, the invention will now be described. The PC (501) will be monitored by attaching a peripheral to PC 501. Non-limiting examples of PCs (501) include laptops, desktops, mini-computers, and other devices with a CPU connected to a buffer that facilitates communication between the CPU and other devices. The peripheral can be a USB card (502) or a component that fits into a PICE slot (503). The software monitors the PC's health and is installed on the peripherals (502 or 503). The software includes the target ranges to be monitored for each component, with non-limiting examples including voltage, component temperature, environmental temperature, fan speed, and airflow rate.

Whenever any of the states of the former are not within the desired range, a fault is detected. The software then communicates the fault to the interested party (504). The fault is transmitted via the communication system installed on the PC (501), with non-limiting examples including wireless communication, e.g., Bluetooth, or wired communication, such as an ethernet connection, or coaxial cable, telephonic communication. Non-limiting examples of the receiver include a wireless receiver, such as a cell phone, Raspberry Pi, or the Cloud, which receives the information and sends it to the interested party.

The interested party (504) may evaluate the fault and take corrective action. The interested party (504) includes, but is not limited to, the PC OEM, a repair service provider, the owner, or others tasked to repair and maintain the PC (501).

### Definitions

The following definitions apply herein unless otherwise indicated.

“Substantially” means more-or-less conforming to the particular dimension, range, shape, concept, or other aspect modified by the term, such that a feature or component need not conform strictly. For example, a “substantially cylindrical” object resembles a cylinder but may have one or more deviations from an actual cylinder.

“Comprising,” “including,” and “having” (and conjugations thereof) are used interchangeably to mean including but not necessarily limited to and are open-ended terms not intended to exclude additional elements or method steps not expressly recited.

Terms such as “first,” “second,” and “third” are used to distinguish or identify various members of a group or the like and are not intended to denote a serial, chronological, or numerical limitation.

“Coupled” means connected, permanently or releasable, directly or indirectly, through intervening components.

“Communicatively coupled” means that an electronic device is connected to another electronic device, either wirelessly or with a wire-based connector, directly or indirectly, through a communication network. “Controllably coupled” means that the electronic device controls the operation of the other electronic device.

Therefore, having thus described the invention, at least the following is claimed:

1. A method for monitoring the internal function of a PC comprising:
Providing a PC capable of transmitting information, attaching a peripheral to the PC, where the peripheral is encoded with software that monitors the installed components of the PC, the PC's internal environment PC, and the software communicates the monitored information via the PC to an interested party.

2. The method of claim 1, where the peripheral is a USB card or a card adapted to fit into a PCI-E slot.

3. The method of claim 2, where the encoded software includes industry-standard ranges for each monitored component.

4. The method of claim 3, where the monitored value includes at least one of the following: component temperature, voltage, air flow, or internal environmental temperature.

5. The method of claim 4, where software detects a fault when the monitored information regarding component temperature, voltage, air flow, or internal environmental temperature exceeds the industry standard range and communicates the fault to said interested party.

6. The method of claim 5, where encoded software can control the airflow to bring the internal temperature back into the industry standard range when a fault is detected.
